(19) United States
(12) Patent Application Publication
(10) Pub. No.: US 2009/0116242 A1
(43) Pub. Date: May 7, 2009

(54) Light emitting diode lamp with high heat dissipation

(76) Inventor: Hsing Chen, Kukou Township (TW)

Correspondence Address: PRO-TECHTOR INTERNATIONAL SERVICES, 20775 NORADA CT., SARATOGA, CA, 95070, US

(21) Appl. No.: 12/009,708

(22) Filed: Jan. 22, 2008

(30) Foreign Application Priority Data
Nov. 6, 2007 (TW) 096218799

(51) Int. Cl. F21V 29/00

(52) U.S. Cl. 362/294

(57) ABSTRACT

A light emitting diode lame with high heat dissipation includes a body; a light emitting diode package is mounted on the body and; a lens is arranged on the light emitting diode package; a cover has a penetrated hole, and covered the lens, so that the lens is exposed from the penetrated hole ; four conductive elements are connected to the body for conducting heat generated by the light diode emitting diode package; a plurality of heat sinks are connected to the conductive elements for dissipating higher heat energy generated from the conductive elements.

### BACKGROUND OF THE INVENTION

1. Field of the Invention

The invention to a light emitting diode lamp with high heat dissipation, and in particular to a light emitting diode lamp that is easy to be fabricated and capable of increasing lifetime of the product.

2. Description of the Related Art

In general, the light emitting diode uses unusual widespread, it has the life to be long and to use the electric quantity low merit, therefore, its may substitute for the traditional lamps and lanterns, like the computer uses back source and street light.

It is very important how to obtain high heat dissipation LED, that is may be produced to generate higher heat energy. Therefore, the heat dissipation effect is very important.

Present the LED power transforms the light ratio is 20-30, others transforms the heat ratio is 20-30. How to attach the heat sink to LED chip directly to obtain heat dissipation effect, and must consider the product the outward appearance design and the volume demand is very important.

### SUMMARY OF THE INVENTION

An objective of the invention is to provide a light emitting diode lamp with high heat dissipation to prolong its durability and lifetime effectively.

Another objective of the invention is to provide a light emitting diode lamp with high heat dissipation that is easy to be fabricated.

To achieve the above-mentioned objective, the invention includes a body, a light emitting diode package, a lens, a cover, four conductive elements, and heat sinks. The light emitting diode package is mounted on the body. The lens is arranged on the light emitting diode package. The cover has a penetrated hole, and is covered the lens, so that the lens is exposed from the penetrated hole. The four conductive elements are connected to the body for conducting heat generated by the light diode emitting diode package. The heat sinks are connected to the conductive elements for dissipating higher heat energy generated from the conductive element.

Therefore, the heat energy generated by light emitting diode package can be dissipated through the heat sinks, so that the durability and lifetime of the light emitting diode can be prolonged effectively.

### BRIEF DESCRIPTION OF THE DRAWINGS

FIG. 1 is a cross-sectional exploded view showing a light emitting diode lamp with high heat dissipation of the present invention.

FIG. 2 is a cross-sectional view showing a light emitting diode lamp with high heat dissipation of the present invention.

FIG. 3 is a schematic illustration showing a light emitting diode lamp with high heat dissipation of the present invention.

### DETAILED DESCRIPTION OF THE INVENTION

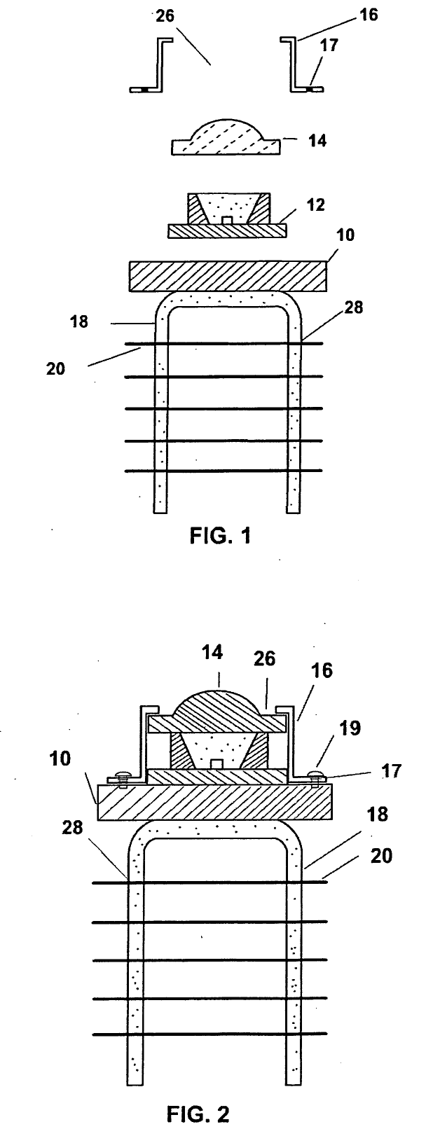

Please refer to FIG. 1, a light emitting diode lamp with high heat dissipation includes a body 10, a light emitting diode package 12, a lens 14, a cover 16, four conductive elements 18, and a plurality of heat sink 20.

The body 10 is a panel shape.

The light emitting diode package 12 is mounted on the body 10.

The lens 14 is arranged on the light emitting diode package 12 for enhancing the light from the light emitting diode package 12.

The cover 16 has a penetrated hole 26 and fixed holes 17. The cover 16 is covered the lens 14, and is mounted at the body 10 by screwed element 19 screwed to the fixed hole 17, so that the lens 14 is exposed from the penetrated hole 26.

Four conductive elements 18 is conductive tube, it are connected to the body 10 for conducting heat energy generated by the light diode emitting diode package 12.

Each of heat sink 20 has four holes 28, so that the four conductive elements 18 may penetrated the holes 28 and mounted to the heat sinks 20. The heat sink 20 may dissipate heat energy from the conductive elements 18.

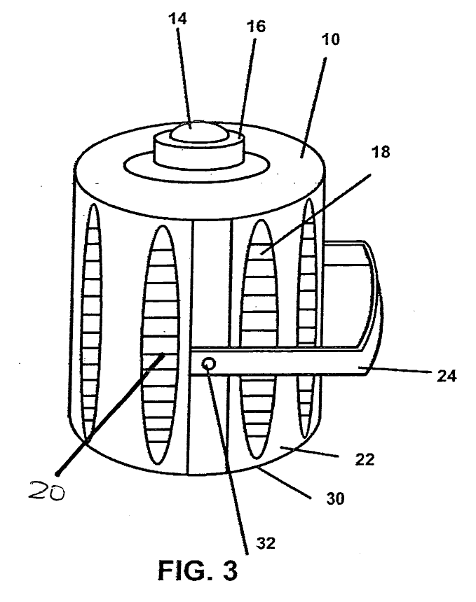

Please refer FIG. 2 and FIG. 3, the cover 16 is mounted on the body 10 through screw element 19 screwed to the fixed hole 17.

The lamp further includes a circular external cover 22 formed with a bottom plane to cover heat sinks 20 and conductive elements 18, and a fixed handle 24 is screwed to the external cover 22, so that the fixed handle 24 may fix to a object.

While the invention has been described by the way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. A light emitting diode lamp with high heat dissipation, the light emitting diode lamp comprising:
a body;
a light emitting diode package mounted on the body;
a lens arranged on the light emitting diode package;
a cover having a penetrated hole, and covered the lens, so that lens is expose from the penetrated hole;
at least a conductive element connected to the body for conducting heat energy generated by the light diode emitting diode package;
a plurality of heat sink connected to the conductive element for dissipating higher heat energy from the conductive element.

2. The light emitting diode lamp with high heat dissipation according to claim 1, wherein the conductive element is tube type.

3. The light emitting diode lamp with high heat dissipation according to claim 1, wherein the lamp includes four conductive elements.

4. The light emitting diode lamp with high heat dissipation according to claim 3, wherein the heat sink has four holes.

5. The light emitting diode lamp with high heat dissipation according to claim 1, wherein the lamp includes an external cover to cover the heat sinks.

6. The light emitting diode lamp with high heat dissipation according to claim 1, wherein the lamp includes a fixed handle mounted at the external cover.
